(19) United States
(12) Patent Application Publication
(10) Pub. No.: US 2025/0118835 A1
(43) Pub. Date: Apr. 10, 2025

(54) Battery Cell Housings and Manufacturing Method

(71) Applicants: Martin Christoph Lentz, Bonn (DE); Holger Aretz, Spessart (DE); Hartmut Janssen, Hilden (DE)

(72) Inventors: Martin Christoph Lentz, Bonn (DE); Holger Aretz, Spessart (DE); Hartmut Janssen, Hilden (DE)

(73) Assignee: Speira GmbH, Grevenbroich (DE)

(21) Appl. No.: 18/987,330

(22) Filed: Dec. 19, 2024

Related U.S. Application Data
(63) Continuation of application No. PCT/EP2023/067886, filed on Jun. 29, 2023.

(30) Foreign Application Priority Data
Jul. 1, 2022 (EP) 22182597.9

(51) Int. Cl. H01M 50/103; H01M 50/119; H01M 50/133; H01M 50/136

(52) U.S. Cl. CPC H01M 50/103; H01M 50/119; H01M 50/133; H01M 50/136

(57) ABSTRACT

A battery cell housing has a battery cell housing jacket with at least in areas a rectangular cross section and which can be manufactured very easily and at the same time allows the use of a wide range of aluminium alloys in order to be able to respond flexibly to various requirements of the battery cell housing. Increased strength requirements or thermal conductivity requirements are achieved in that the battery cell housing has a roll-formed tubular body made of an aluminium alloy as the battery cell housing jacket. The battery cell housing jacket is joined in the longitudinal direction and has at least in areas a rectangular cross section. The battery cell housing jacket is preferably being roll-formed from an aluminium alloy strip.

### CROSS-REFERENCE TO RELATED PATENT APPLICATIONS

This patent application is a continuation of International Application No. PCT/EP2023/067886, filed on Jun. 29, 2023, which claims the benefit of priority to European Patent Application No. 22182597.9, filed Jul. 1, 2022, the entire teachings and disclosures of both applications are incorporated herein by reference thereto.

### FIELD OF THE INVENTION

The invention relates to a battery cell housing and to a method for manufacturing a battery cell housing.

### BACKGROUND OF THE INVENTION

Battery cell housings are manufactured in a wide variety of shapes. In addition to the pouch shape and cylindrical battery cell housings, a prismatic battery cell housing is also often used. Prismatic battery cell housings consist of a battery cell housing jacket, which has a substantially rectangular cross section and thus enables a simple and space-saving arrangement of battery cells. Prismatic battery cell housings have a battery cell housing base and a battery cell housing lid with means for contacting the two electrical terminals of the battery cell.

Currently, prismatic battery cell housings in the form of prismatic cups are predominantly manufactured by means of combined deep drawing and stretching processes with a multitude of drawing stages from a sheet metal blank made from an aluminium alloy strip. Due to the large number of drawing stages in the manufacturing process, only aluminium alloys with particularly good deep drawing properties can be used to manufacture the housing. The large number of drawing stages increases the costs of the process.

Alternatively, extrusion may also be used. Extrusion works best with soft aluminium alloys. Aluminium alloys with higher strength lead to increased pressing forces and reduce productivity. Soft aluminium alloys have the disadvantage that they are less suitable for achieving the strength requirements of the battery cell housing with a low weight.

A battery cell housing is known from the US patent application US 2022/0102787 A1, which discloses a battery cell volume of more than 50% by providing elongated, rectangular individual battery cells. The way in which the individual, prismatic battery cell housings are manufactured is not disclosed.

### SUMMARY OF THE INVENTION

On this basis, it is an object of the present invention to provide a battery cell housing which can be manufactured very easily and at the same time allows the use of a broad spectrum of aluminium alloys as well as housing dimensions in order to be able to respond flexibly to different requirements of the battery cell housing, for example increased strength requirements, thermal conductivity requirements or installation space requirements. It is furthermore an object of the invention to propose a method for manufacturing the battery cell housing according to the invention.

According to a first teaching of the invention, the aforementioned object is achieved in that the battery cell housing has a roll-formed tubular body made of an aluminium alloy as the battery cell housing jacket, the battery cell housing jacket being joined in the longitudinal direction, preferably with a form-fit, friction-fit and/or materially, and having at least in areas a rectangular cross section, the battery cell housing jacket preferably being roll-formed from an aluminium alloy strip.

The longitudinal direction of the battery cell housing jacket refers here to the axis of the tubular body, which is perpendicular to the tube cross section. By making the battery cell housing jacket from tubular bodies roll-formed and longitudinally seam-joined with a form-fit, friction-fit and/or materially, it may be manufactured from a very wide variety of aluminium alloys very precisely and in large quantities. The height and width of the battery cell housing jacket may be adjusted very precisely and at the same time flexibly by the roll forming process. The length of the battery cell housing jacket, i.e. the extent of the battery cell housing jacket in the longitudinal direction, may likewise be selected very variably by dividing the roll-formed tubular body to length and provide very precise geometries of the battery cell housing jacket.

The tubular body may optionally be coated after the longitudinal form-fit, friction-fit and/or material seam joining in order to provide a battery cell housing jacket having a coated surface. With roll forming of coated aluminium strips it is furthermore possible to provide a coated battery cell housing jacket. These have the advantage that the battery cell housing jacket may be electrically insulated from the electrode winding or electrode stack, for example, and the corrosion protection of the battery cell housing jacket is furthermore improved.

Welding methods such as metal inert gas welding (MIG welding), friction agitation welding, laser welding or induction welding, as well as soldering, adhesive bonding and flanging, are possible joining methods for the form-fit, friction-fit and/or material connection in the longitudinal direction. According to one preferred embodiment, the battery cell housing jacket is longitudinally seam-welded and has a weld seam in the longitudinal direction. The longitudinal seam welding of tubular bodies is a technology known from tube manufacture, which can generate high welding speeds and a high-quality weld seam on the battery cell housing jacket. The longitudinal seam welding may take place inline with the manufacture of the battery cell housing jacket, for example after the roll forming and before the cutting of the battery cell housing to length.

To fulfil the desired strength requirements of the battery cell housing as a function of the selected aluminium alloy, according to a further embodiment the wall thickness of the battery cell housing jacket is preferably 0.2 mm to 1.2 mm. Aluminium alloys with higher strength allow smaller wall thicknesses with larger internal volumes. These in turn allow the volumetric energy density of the battery cell to be optimised, since a larger volume fraction of the battery cell is available for active material.

In a further configuration of the prismatic battery cell housing, the ratio of height to width of the battery cell housing jacket is more than 3 and less than 10, preferably 5 to 8. The ratio of height to width of the battery cell housing jacket may be provided in a straightforward way by means of a roll forming process.

If, according to a next configuration of the prismatic battery cell housing, the inner radii Rᵢ of the battery cell housing jacket fulfil the following condition with respect to the thickness d of the aluminium alloy strip:

Rᵢ≤2.5*d, preferably Rᵢ≤1.5*d or particularly preferably 0.1*d≤Rᵢ≤1.5*d, on the one hand good stability of the battery cell housing may be achieved and, on the other hand, an optimised internal volume of the battery cell housing may be provided since sufficient space is available for arrangement of an electrode winding or electrode stack of the battery cell without any problem.

In a further configuration of the battery cell housing, the battery cell housing jacket has at least one pressure relief means, preferably at least one bursting element and/or pressure valve, which protects the battery cell housing from exceeding a critical pressure inside the battery cell housing. The at least one pressure relief means may be introduced or arranged in or on the battery cell housing jacket before, during or after the roll forming process, for example by lasering, embossing, punching, friction-fit and/or materially bonded insertion. The pressure relief means can trigger in the event of a pressure increase inside the battery cell housing to, for example, more than 5 bar, preferably more than 7.5 bar, in order to avoid a further pressure increase and/or to reduce the pressure in order to avoid critical thermal runaway in the battery cell.

A joining seam, in particular a weld seam, is preferably arranged on the long-narrow surface of the battery cell housing jacket. The long-narrow surface means the side of the battery cell housing jacket which has the smaller width perpendicularly to the roll forming direction, i.e. the longitudinal direction of the battery cell housing jacket. This results in good joinability or weldability of the roll-formed tubular body in the longitudinal direction in combination with a comparatively low mechanical load in the event of a pressure increase during operation of the battery or in the event of damage. At the same time, the long-narrow surface allows even greater dimensional tolerance with respect to the formation of the joining or welding seam without having a damaging effect on the electrode winding or electrode stack.

The weldability of the roll-formed aluminium alloy strip, in particular during MIG welding or induction welding of the roll-formed aluminium alloy strip, is improved by the surface tension of the surface of the roll-formed aluminium alloy strip being more than 30 mN/m preferably more than 40 mN/m, particularly preferably more than 50 mN/m, preferably immediately before the welding. The surface tension of the surface of the roll-formed aluminium strip may for example be measured with good accuracy by using test inks. For this purpose, the aluminium alloy strip is subjected to degreasing or a corona treatment using plasma. This may, for example, take place inline with the manufacture of the welded housing cell jacket.

Preferably, the battery cell housing jacket consists of an aluminium alloy having the following composition in wt %:
Si <0.5%,
Fe <0.8%,
Cu <0.5%,
Mn ≤ 1.5%,
Mg <1.3%, preferably <0.5% or 2.5%<Mg<6.0%, preferably 3.0%<Mg<6.0%
Cr <0.2%,
Zn <0.25%,
Ti ≤ 0.1%, preferably 0.001%≤Ti≤0.1%,
the remainder being Al and unavoidable impurities, individually at most 0.05% and in total at most 0.15%.

Aluminium alloys having the aforementioned composition may in principle be roll-formed well and are furthermore weldable. Further, they may provide different strength properties of the battery cell housing jacket, for example depending on the copper, manganese or magnesium content. Si contents of less than 0.5 wt % allow a low hot cracking tendency during the welding of the battery cell housing jacket. Fe contents of less than 0.8 wt % also allow a high proportion of recycling and moreover bind Si in combination with Mn and Al into AlMnFeSi phases, which further reduces the hot cracking tendency during welding. Cu contents of less than 0.5 wt % allow the strength-increasing effect of copper to be utilised without significantly impairing the corrosion resistance. Furthermore, higher Cu contents would increase the hot cracking tendency. Mn contents of less than 1.5 wt %, preferably less than 1.2 wt %, allow precise control of the recrystallization and the texture by the formation of dispersoids and increase in particular the thermal stability of the aluminium alloy. Furthermore, Mn forms AlMnFeSi phases in combination with Fe and Si, which lower the Si content in the solid solution and thereby reduce the hot cracking tendency. Mg contents of less than 1.0 wt %, preferably less than 0.5 wt %, result in a moderate increase in strength with a low hot cracking tendency during welding. Cr contents of less than 0.2 wt % are suitable for the formation of further dispersoid phases, which in turn stabilise the microstructure under thermal stress. Zn contents of less than 0.25 wt % and Ti contents of at most 0.1 wt % or from 0.001 wt % to at most 0.1 wt % make it possible to use recycled alloys, in particular recycled alloys containing Mn. Furthermore, the Ti content of 0.001 wt % to 0.1 wt % allows the addition of Ti-based grain refining additives in order to optimise the casting structure. Limiting the unavoidable impurities individually to at most 0.05 wt % and in total to at most 0.15 wt % does not alter the positive effects of the alloy constituents.

Alternatively, there may also be an Mg content of more than 2.5 wt % and less than 6.0 wt %, preferably more than 3.0 wt % and less than 6.0 wt %, in order to provide the highest possible strength of the battery cell housing jacket with a minimal wall thickness and thus with an optimised weight of the prismatic battery cell as well as a low hot cracking tendency during welding and therefore a high process reliability.

If the strength and weight of the battery cell housing are not of paramount importance, but rather the best possible thermal conductivity, it is advantageous for the battery cell housing jacket to consist of an aluminium alloy of the type AA1xxx having the following composition in wt %:
Si<0.25%,
Fe<0.4%,
Cu<0.2%,
Mn≤0.05%,
Mg<0.5%,
Cr<0.2%,
Zn<0.1%,
0.001%≤Ti≤0.1%,
the remainder being Al and unavoidable impurities, individually at most 0.05% and in total at most 0.15%.

AA1xxx aluminium alloys, for example of the type AA1050, can be welded very well because the proportion of alloying elements that increase the hot cracking tendency (Si, Cu, Mg) is very limited. Furthermore, these alloys have a high corrosion resistance. Further, they provide sufficiently high strengths with at the same time a very high thermal conductivity in the mill-hard state H18. A high thermal conductivity of the battery cell housing ensures rapid dissipation of heat from inside the battery cell and therefore improved performance of the battery cell, especially in the event of high charging or discharging rates. Si contents of less than 0.25 wt % are preferable in order to minimise the hot cracking tendency in the welding process. Fe contents of less than 0.4 wt % allow the use of commercially pure as well as industrial primary metal, which is preferable in terms of availability and costs. Cu contents of less than 0.2 wt % allow the alloying of copper in order to increase the strength by solid solution formation while at the same time minimising the hot cracking tendency. Mn has a strongly negative effect on the electrical and thermal conductivity of aluminium alloys both dissolved and in intermetallic phases and is therefore limited to less than 0.05 wt %. Mg contributes to the strength by means of solid solution hardening, especially in cold-hardened states. However, the hot cracking tendency increases with an increasing Mg content, so that the Mg content is limited to <0.5 wt %. As a dispersoid former, Cr contributes to control of the microstructure in recovery and recrystallization processes as well as to stabilisation of the microstructure under thermal stress. However, Cr impairs the electrical and thermal conductivity, so that the Cr content is limited to less than 0.2 wt %. Zn impairs the corrosion resistance and is therefore limited to less than 0.1 wt %. Ti is used for grain refining or in order to optimise the casting structure during the casting process. However, Ti impairs the electrical and thermal conductivity comparatively strongly, so that the Ti content is limited to 0.001 wt %≤Ti≤0.1 wt %.

According to a further configuration, the battery cell housing jacket consists of an aluminium alloy of the type AA3xxx having the following composition in wt %:
Si<0.6%,
Fe<0.8%,
Cu≤0.5%,
0,3%≤Mn≤1.5%, preferably 0.6%≤Mn≤1.2%
Mg<1.3%, preferably 0.8%≤Mg≤1.3%, more preferably 0.01%<Mg<0.5%
Cr<0.2%,
Zn<0.25%,
Ti≤0.1%, preferably 0.001 wt %≤Ti≤0.1 wt %,
the remainder being Al and unavoidable impurities, individually at most 0.05% and in total at most 0.15%.

AA3xxx aluminium alloys, for example of the type AA3003, provide higher maximum strengths than AA1xxx aluminium alloys, in particular higher maximum values for the yield strength R_{p0.2.} In combination with the iron and manganese contents according to the invention in the amounts specified, a silicon content of Si less than 0.6 wt % leads in particular to relatively uniformly distributed, compact particles of the quaternary α-Al(Fe,Mn)Si phase. These precipitated particles increase both the strength of the aluminium alloy and its electrical and thermal conductivity, since they remove iron and manganese from the solid solution without detrimentally affecting other properties such as corrosion behaviour, i.e. the electrolyte stability, or formability. The iron content of less than 0.8 wt % leads in combination with the manganese content according to the invention in the amount specified to the formation of Al₆(Mn,Fe) phases and, as already explained above, in combination with the silicon and manganese contents according to the invention in the amounts specified to the precipitation of particles of the quaternary α-Al(Fe,Mn) Si phase. Iron in this case contributes to lowering the solubility of manganese in aluminium, so that more manganese is bound in intermetallic phases, which has a positive effect on the electrical and thermal conductivity. Moreover, the intermetallic phases influence recovery and recrystallisation processes and improve the thermal stability of the mechanical properties. Iron contents of more than 0.8 wt % promote the formation of coarse intermetallic phases, which may impair the formability in the deep drawing process. Because a maximum copper content of at most 0.5 wt % is permitted, the strength of the alloy may be increased by solid solution formation. Furthermore, an increased tolerance of the aluminium alloy for copper-containing aluminium alloy scrap is achieved, which promotes the achievement of high proportions of recycled material in the manufacture of the battery housing. However, since excessively high copper contents may have a detrimental effect on the corrosion properties, the copper content is limited according to the invention to at most 0.5 wt % in order to achieve a sufficiently high electrolyte stability. As already explained above, the manganese content of 0.3 wt %≤Mn≤1.5 wt %, preferably 0.6 wt %≤Mn≤1.2 wt %, leads in combination with the silicon and iron contents in the amounts specified to the precipitation of particles of the quaternary α-Al(Fe,Mn)Si phase as well as the Al₆(Mn, Fe) phase. The intermetallic phases hinder recovery and recrystallisation processes and therefore improve the thermal stability of the mechanical properties. Manganese contents of less than 0.6 wt % already reduce the increase in strength by dispersoid and solid solution hardening. Mn contents below 0.3 wt % lead to an insufficient increase in strength due to dispersoid and solid solution hardening compared to the 1xxx alloy with impairment of the thermal and electrical conductivity, whereas manganese contents of more than 1.5 wt %, in particular more than 1.2 wt %, promote the formation of coarse intermetallic phases which have an adverse effect on the forming properties. Furthermore, manganese contents of more than 1.5 wt %, in particular more than 1.2 wt %, reduce the electrical and thermal conductivity of the battery cell housing so greatly that the thermal management becomes inefficient. In order to achieve improved mechanical properties with still good weldability, the magnesium content in the aforementioned embodiment is limited to less than 1.3 wt %, preferably 0.8 wt %≤Mg≤1.3 wt %, more preferably 0.01%<Mg<0.5%. The preferred ranges represent compromises between high strength, good forming behaviour and high electrical and thermal conductivity with at the same time good weldability and recycling tolerance in relation to scrap containing Mn. With higher Mg contents, strength and forming behaviour are promoted with a somewhat reduced electrical and thermal conductivity. With lower Mg contents, electrical and thermal conductivity are promoted with reduced strengths. As a dispersoid former, Cr contributes to control of the microstructure in recovery and recrystallization processes as well as to stabilisation of the microstructure under thermal stress. However, Cr impairs the electrical and thermal conductivity, so that the Cr content is limited to less than 0.2 wt %. Zn impairs the corrosion resistance and is therefore limited to less than 0.25 wt %. Ti is used for grain refining or in order to optimise the casting structure during the casting process. However,

Ti impairs the electrical and thermal conductivity comparatively strongly, so that the Ti content is limited to at most 0.1 wt %, preferably to 0.001 wt %≤Ti≤0.1 wt %. AA3xxx aluminium alloys are also highly formable and can be welded and soldered well. The aforementioned upper limits for silicon, iron, copper, magnesium, chromium, zinc and titanium lead to a good suitability of the aluminium alloy for the use of high proportions of recycling in the aluminium alloy of at least 70% to more than 90%. Sufficient strengths for the battery cell housing jacket are already achieved, for example, for aluminium alloys of the type AA3003 in the state H14 or H16. Higher-strength AA3xxx aluminium alloys, such as AA3104, likewise already achieve these properties in the state H14.

In order to provide even higher strengths, according to a further configuration the battery cell housing jacket consists of an aluminium alloy of the type AA5xxx having the following composition in wt %:
Si<0.3%,
Fe<0.4%,
Cu<0.2%,
Mn<0.8%,
2.5%<Mg<6.0%, preferably 3.0%<Mg<6.0%,
Cr<0.2%,
Zn<0.25%,
Ti≤0.1%, preferably 0.001%≤Ti≤0.1%,
the remainder being A1 and unavoidable impurities, individually at most 0.05% and in total at most 0.15%.

Because of the high achievable strengths, battery cell housing jackets made of AA5xxx alloys can fulfil demanding load requirements and therefore be considered, for example, as structural components in vehicles. The Mg content of more than 2.5 wt %, preferably more than 3.0 wt %, is responsible for the increase in the strength. With these Mg contents, furthermore, the maximum hot cracking tendency is already exceeded so that Mg contents of more than 2.5 wt %, preferably more than 3.0 wt %, enable an efficient welding process. With at least 6.0 wt %, processing of the aluminium alloy by cold rolling becomes increasingly difficult since the solidification increases greatly during cold rolling and the susceptibility to intercrystalline corrosion rises greatly. Si contents of less than 0.3 wt % are preferable in order to minimise the hot cracking tendency during the welding process and to avoid the formation of Mg₂Si phases, which remove Mg from the solid solution and therefore reduce the solid solution hardening. Fe is present as an impurity in industrial primary metal as well as through recycling. Fe contents of less than 0.4 wt % lead in combination with Mn contents of less than 0.8 wt % to the formation of AlMnFe phases, which as dispersoids contribute to efficient control of the recrystallization and recovery and therefore allow optimization of the grain structure. Higher Fe contents may lead to the formation of coarse intermetallic phases, whereas Mn contents above 0.8 wt % significantly reduce thermal and electrical conductivity. As a dispersoid former, Cr contributes to control of the microstructure in recovery and recrystallization processes as well as to stabilisation of the microstructure under thermal stress. However, Cr impairs the electrical and thermal conductivity, so that the Cr content is limited to less than 0.2 wt %. Zn impairs the corrosion resistance and is therefore limited to less than 0.25 wt %. Ti is used for grain refining or in order to optimise the casting structure during the casting process. However, Ti reduces the electrical and thermal conductivity comparatively strongly, so that the Ti content is limited to at most 0.1 wt %, preferably 0.001 wt %≤Ti≤0.1 wt %.

In order for battery cell housings to achieve sufficient pressure stability, a sufficiently high strength of the battery cell housing jacket is required. Battery cell housing jackets made of roll-formed aluminium alloy strips consisting of the alloy type AA 5754, for example, already achieve sufficient strengths in the state H12. If aluminium alloy strips consisting of an aluminium alloy of the type AA 5083 are used to manufacture the battery cell housing jacket, these already achieve sufficient strengths in the soft annealed state O.

If the aluminium alloy strip, from which the battery cell housing jacket of the battery cell housing is roll-formed, according to a next configuration has a yield strength Rp0.2 of at least 120 MPa, preferably at least 150 MPa, this ensures that the battery cell housing achieves a sufficient pressure stability, particularly with respect to the strength of the battery cell housing jacket, without requiring an excessively large wall thickness which would significantly reduce the volumetric energy density of the battery cell.

Finally, the battery cell housing according to a next configuration has two lids connected to the battery cell housing jacket with a form-fit, friction-fit and/or materially. The lids may be made from a wide range of materials. Plastics as well as ceramic materials or stamped aluminium alloy sheets are suitable for this purpose. The lids may be adhesively bonded, welded or soldered to form a material-fit connection. Laser welding or laser soldering may for example be suitable for lids made of aluminium alloys. Flanging may, however, also be envisaged for form-fit and/or friction-fit connection in the case of aluminium materials.

The object presented above is also achieved with a method for manufacturing a battery cell housing according to the invention, in that
an aluminium alloy strip is manufactured by hot and/or cold rolling from an ingot or a cast strip,
the rolled aluminium alloy strip is further processed by means of roll forming and longitudinal form-fit, friction-fit and/or material seam joining, in particular longitudinal seam welding, to form a closed tube with at least in areas a rectangular cross section, and
the roll-formed and joined tube is divided perpendicularly to its longitudinal axis into shorter subsections, which are used as the battery cell housing jacket.

With the method according to the invention, battery cell housings with at least in areas a rectangular cross section may be manufactured in a simple and economical manner, and different aluminium alloys may in principle be used in order to be able to fulfil various requirements for the battery cell housings.

The welding speed during the longitudinal seam welding may preferably be more than 2.5 m/min, more than 5 m/min or preferably more than 10 m/min. By using different aluminium alloys, for example aluminium alloys of the type AA1xxx with high thermal conductivity, through recycling-friendly aluminium alloys of the type AA3xxx to high-strength aluminium alloys of the type AA5xxx, battery cell housings having a battery cell housing jacket with at least in areas a rectangular cross section may be manufactured with the same process.

Preferably, according to a first embodiment of the method, post-processing of the weld seam root is carried out for weld seam root smoothing. This may further reduce the influence of the weld seam root on the electrode winding or electrode stack of the battery cell. This method step may take place immediately following the welding, in particular the longitudinal seam welding. Weld seam root smoothing may, for example, be carried out by reheating the weld seam with a welding beam in thermal conduction mode.

According to a further configuration of the method, after cutting the battery cell housing jacket to the required length, one of the two previously open end faces of the battery cell housing jacket is closed with a form-fit, friction-fit and/or materially by a lid in order to provide a battery cell housing in the form of a cup with at least in areas a rectangular cross section for receiving the electrode winding or electrode stack.

An electrode winding or electrode stack may then be inserted into this cup, which is closed on one side, in further automated steps and the filled with electrolyte. The cell housing may then be closed with a form-fit, friction-fit and/or materially by a second lid to form a finished prismatic battery.

Alternatively, the electrode winding or the electrode stack may initially be inserted into the battery cell housing jacket so that particularly good accessibility of the joining zones for connecting the electrode stacks to the terminals is ensured. The battery cell housing may then initially be closed on one side with a form-fit, friction-fit and/or materially by a lid so as to form a cup, which may be filled with electrolyte in the further manufacturing process and then with a form-fit, friction-fit and/or materially by the second lid. Alternatively, filling with electrolyte through the lid after the form-fit, friction-fit and/or material closure of the battery cell housing on both sides may be envisaged.

### BRIEF DESCRIPTION OF THE DRAWINGS

The invention will be described in more detail below with the aid of embodiments in combination with the figures. In the drawing,

FIG. 1 shows a schematic representation of an exemplary embodiment of a battery cell housing jacket of a prismatic battery cell housing,

FIG. 2 and FIG. 3 show a schematic plan view of two lids for the prismatic battery cell housing of FIG. 1 and

FIG. 4 shows a schematic view an exemplary embodiment of a method according to the invention for manufacturing a battery cell housing.

### DETAILED DESCRIPTION

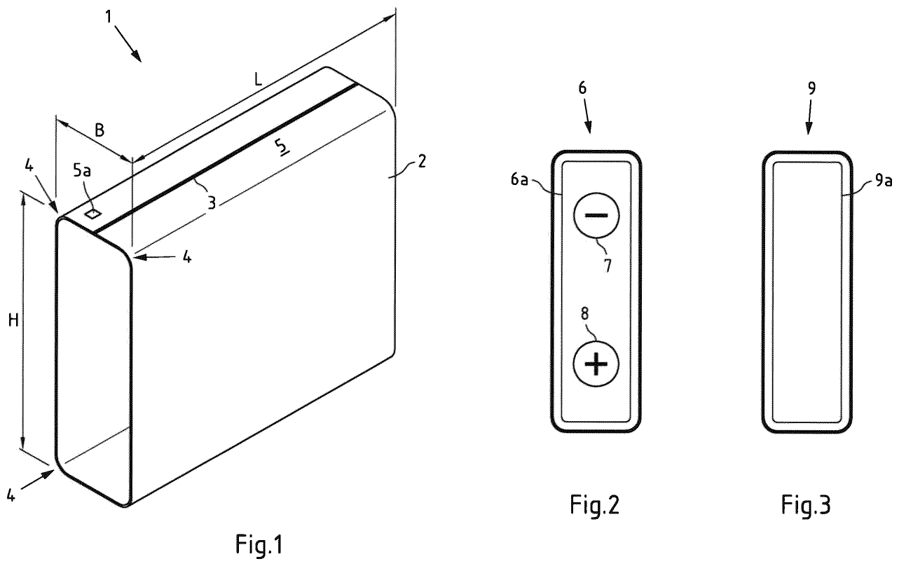

FIG. 1 shows an exemplary embodiment of a battery cell housing jacket 1 of a battery cell housing, which has a welded, roll-formed tubular body with at least in areas a rectangular cross section. The battery cell housing jacket 1 is roll-formed from an aluminium alloy strip 2. The battery cell housing jacket 1 of the exemplary embodiment is longitudinally seam-joined with a form-fit, friction-fit and/or materially, in the present case longitudinally seam-welded. The weld seam 3 of the battery cell housing jacket 1 is provided in the present exemplary embodiment on the long-narrow side 5 of the battery cell housing jacket.

Preferably, the wall thickness of the battery cell housing jacket is 0.2 mm to 1.2 mm. By means of the wall thickness in combination with the selection of an aluminium alloy, specific properties may be provided for the battery cell housing jacket 1 with at least in areas a rectangular cross section and thus for the corresponding battery cell housing.

Preferably, the aluminium alloy of the battery cell housing jacket 1 has the following alloy composition in wt %:
Si<0.5%,
Fe<0.8%,
Cu<0.5%,
Mn≤ 1.5%,
Mg<1.3%, preferably <0.5% or 2.5%<Mg<6.0%, preferably 3.0%<Mg<6.0%
Cr<0.2%,
Zn<0.25%,
0.001%<Ti<0.1%, the remainder being A1 and unavoidable impurities, individually at most 0.05% and in total at most 0.15%.

Further, the battery cell housing jacket 1 may also consist of an aluminium alloy of the type AA1xxx having the following composition in wt %:
Si<0.25%,
Fe<0.4%,
Cu<0.2%,
Mn≤0.05%,
Mg<0.5%,
Cr<0.2%,
Zn<0.1%,
0.001%<Ti<0.1%,
the remainder being A1 and unavoidable impurities, individually at most 0.05% and in total at most 0.15% or
of an aluminium alloy of the type AA3xxx having the following composition in wt %:
Si<0.6%,
Fe<0.8%,
Cu≤0.5%,
0,3%≤Mn≤1.5%, preferably 0.6%≤Mn≤1.2%
Mg<1.3%, preferably 0.8%≤Mg≤1.3%, more preferably 0.01%<Mg<0.5%,
Cr<0.2%,
Zn<0.25%,
0.001%<Ti<0.1%,
the remainder being A1 and unavoidable impurities, individually at most 0.05% and in total at most 0.15% or
an aluminium alloy of the type AA5xxx having the following composition in wt %:
Si <0.3%,
Fe <0.4%,
Cu <0.2%,
Mn<0.8%,
2.5%<Mg<6.0%, preferably 3.0%<Mg<6.0%,
Cr<0.2%,
Zn<0.25%,
0.001%<Ti<0.1%,
the remainder being A1 and unavoidable impurities, individually at most 0.05% and in total at most 0.15%.

Battery cell housing jackets 1 of a battery cell housing may be manufactured by roll forming from aluminium strips consisting of the aforementioned different aluminium alloys. The various compositions of the aluminium alloys lead to a different property profile of the battery cell housing, or of the battery cell housing jacket 1. For instance, A1xxx aluminium alloys have, in addition to high corrosion resistance, above all a maximum thermal conductivity with preferred values for the yield strength R_{p0.2} in the mill-hard state H18 or H19. AA3xxx aluminium alloys have very good formability as well as good weldability or solderability and a high thermal stability. The recycling-friendly AA3xxx aluminium alloys already achieve preferred strengths, in particular yield strengths R_{p0.2}, in the states H14 and H16 and may consist of up to more than 90% recycled aluminium. AA5xxx aluminium alloys may already provide preferred values for the yield strength R_{p0.2} paired with high ductility in the states O or H12. In these structural states or states with a higher yield strength R_{p0.2} with at the same time high ductility, particularly low wall thicknesses for battery cell housing jackets 1 may be used for AA5xxx aluminium alloys and thus serve for volume optimization for the electrode winding or electrode stack of the battery cell.

The length of the battery cell housing jacket L may, for example, be 100 mm to 400 mm. Longer lengths L are also conceivable and may be provided without problems by means of the roll-formed battery cell housing jacket 1.

According to the exemplary embodiment represented in FIG. 1, the ratio of height H to width B of the battery cell housing jacket may be more than 3 and less than 10,preferably 5 to 8. The width B may for example vary from 15 to 45 mm, and the height H for example from 50 to 200 mm.

Preferably, the inner radii Rᵢ of the battery cell housing jacket 1 have, with respect to the thickness of each roll-formed aluminium alloy strip 2, at most 2.5 times, at most 1.5 times or at most 0.1 times up to 1.5 times the sheet thickness d of the aluminium strip 2.

These inner radii Rᵢ lead to a high packing density and therefore to optimization of the volumetric energy density of the battery cells that can be achieved with the battery cell housings according to the invention, and at the same time enable reliable manufacture of the battery cell housing jacket 1 by roll forming.

As the exemplary embodiment also shows, the weld seam is preferably arranged on the long-narrow surface 5 of the battery cell housing jacket 1 since this position experiences a low load with an increase in the internal pressure and is sufficiently accessible for a longitudinal seam welding process.

On the long-narrow side 5, preferably at least one pressure relief means, represented here as bursting element 5a, is also provided. The bursting element 5a is configured in the form of embossing or lasering. The material in the region of the bursting element is thinned by the embossing or converted locally into a soft state using a laser, in such a way as to deliberately weaken the battery cell housing at this point so that the pressure stability is reduced locally in the region of the bursting element compared to its surrounding area beyond a specific internal pressure. If the internal pressure of the battery cell housing is impermissibly high, it may be purposely relieved in order to prevent uncontrolled bursting of the entire battery cell housing in the event of critical thermal runaway occurring and therefore substantially maintain its structural integrity.

The aluminium strip of the battery cell housing jacket 1 preferably has a value for the yield strength R_{p0.2} of at least 120 MPa, preferably more than 150 MPa. This ensures that the battery cell housing jacket 1 has very good pressure stability, in particular internal pressure stability.

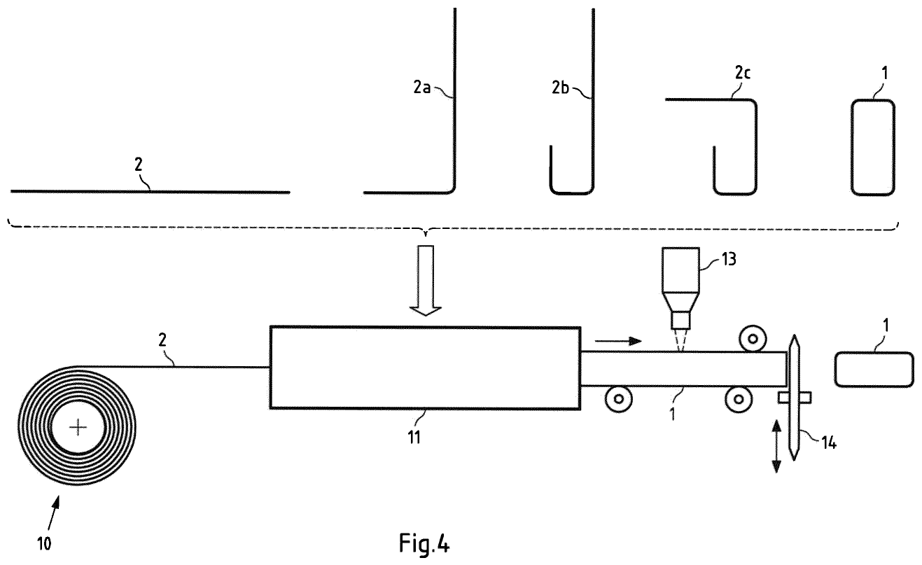

FIG. 2 and FIG. 3 schematically represent a plan view of the upper lid 6 and the lower lid 9 of a battery cell housing, which has a battery cell housing jacket 1. An additional embossing line 6a or 9a on the lids 6 and 9 leads to stiffening of the lid of the battery cell housing and may, for example, be introduced easily when using aluminium alloys for manufacturing the lids. In order to feed through electrical contacts of the electrode winding of the battery cell, schematically two cutouts 7 and 8 are provided in the lid in FIG. 2, which are respectively intended to receive the terminals of the battery cell. The terminals are denoted with a minus and a plus. The electrical contacts may be fed through a lid on one side. Alternatively, an electrical contact may respectively be fed through each lid, so that a plurality of battery cells may be interconnected at the respective lids on the tube ends.

The lids 6 and 9 may be connected to the battery cell housing jacket 1 in a different or similar manner by form-fit, friction-fit and/or material connection, in which case different joining techniques such as welding, soldering and/or adhesive bonding or combinations of several joining techniques may be suitable.

In addition, the geometry of the lids may be used to create a purely frictional connection or a combination of form-locking, frictional and/or material-locking connections. At the same time, however, a lid connected purely with a form-fit to the battery cell housing may also be provided, for example if the lid 6 or 9 is flanged to a battery cell housing jacket. Furthermore, the use of different materials, for example plastics or ceramics, may also be envisaged for the lids 6 and 9 of the battery cell housing. The connection technology for connecting the battery cell housing jacket 1 to the lids 6, 9 is therefore dependent on the selected material of the lids.

FIG. 4 now shows a schematic representation of an exemplary embodiment of a method for manufacturing a battery cell housing having a battery cell housing jacket with at least in areas a rectangular cross section, in which an aluminium alloy strip is manufactured from an aluminium alloy by hot and/or cold rolling from a bar or a casting strip, the rolled aluminium alloy strip 2 is roll-formed into a tubular battery cell housing jacket 1 with at least in areas a rectangular cross section, and the battery cell housing jacket 1 is welded and cut to length.

In FIG. 4 schematically represents an aluminium alloy strip 2 wound on a coil 10. The aluminium alloy strip 2 is unwound from this aluminium coil 10 and fed to a roll forming device 11. Then, as shown in FIG. 4, the aluminium alloy strip 2 is then roll-formed in the roll forming device 11, for example in various substeps 2a, 2b, 2c, into a battery cell housing jacket 1 with a rectangular cross section. At the end of the roll forming process, a tubular battery cell housing jacket leaves the roll forming device 11.

The tubular battery cell housing jacket 1 with a rectangular cross section leaves the roll forming device 11 and is longitudinally seam-welded using welding means 13. Not represented in FIG. 4 is further processing of the weld seam root, for example weld smoothing or other post-processing of the weld seam. Further, before and/or after the longitudinal seam joining or welding of the battery cell housing jacket 1, at least one bursting element may be introduced into the battery cell housing jacket 1 by means of an embossing. Battery cell housing jackets 1 with a predefined length L are then cut off using cutting means 14.

For example, the possibility of coating the battery cell housing jacket 1 before or after the welding is not represented. Alternatively, the manufactured battery cell housing jackets 1 may also be sent for individual coating.

It is not represented in FIG. 4 that, after cutting the battery cell housing jacket to the required length, one of the two open end faces of the battery cell housing jacket may be closed with a form-fit, friction-fit and/or materially by a lid in order to provide a battery cell housing in the form of a cup that is now open on one side with at least in areas a rectangular cross section for receiving the electrode winding or electrode stack, followed by filling with an electrolyte. After the closure of the previously still other side of the cup-shaped battery cell housing, including the provision of the connection terminals of the battery cell, a finished battery cell having a battery cell housing jacket 1 with at least in areas a rectangular cross section is available.

All of the previously described production steps may be carried out in a highly automated manner and provide economical mass production of battery cell housing jackets 1 in a very wide variety of shapes and lengths. Thus, battery cell housings with at least in areas a rectangular cross section of the battery cell housing jacket 1 may be manufactured economically for a very wide variety of applications and with a very wide variety of properties with respect to the strength of the battery cell housing or, for example, the thermal conductivity of the battery cell housing.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A battery cell housing, wherein the battery cell housing has a roll-formed tubular body made of an aluminium alloy as the battery cell housing jacket, the battery cell housing jacket is joined in the longitudinal direction and has at least in areas a rectangular cross section, the battery cell housing jacket is preferably roll-formed from an aluminium alloy strip and the battery cell housing has two lids connected to the battery cell housing jacket with a form-fit, friction-fit and/or materially,
wherein
the aluminium alloy strip, from which the battery cell housing jacket of the battery cell housing is roll-formed, comprises a yield strength Rp0.2 of at least 120 MPa, preferably at least 150 MPa, wherein the battery cell housing jacket consists of an aluminium alloy having the following composition in wt %:
Si<0.5%,
Fe<0.8%,
Cu<0.5%,
Mn≤1.5%,
Mg<1.3%, preferably <0.5% or 2.5%<Mg<6.0%,
preferably 3.0%<Mg<6.0%,
Cr<0.2%,
Zn<0.25%,
Ti≤0.1%, preferably 0.001%≤Ti≤0.1%,
the remainder being Al and unavoidable impurities, individually at most 0.05% and in total at most 0.15%.

2. The battery cell housing according to claim 1,
wherein
the battery cell housing jacket is longitudinally seam-welded and has a weld seam in the longitudinal direction.

3. The battery cell housing according to claim 1,
wherein
the wall thickness of the battery cell housing jacket is 0.2 mm to 1.2 mm.

4. The battery cell housing according to claim 1,
wherein
the ratio of height (H) to width (B) of the battery cell housing jacket is more than 3 and less than 10, preferably 5 to 8.

5. The battery cell housing according to claim 1,
wherein
the inner radii Rᵢ of the battery cell housing jacket fulfil the following condition with respect to the thickness d of the roll-formed aluminium alloy strip: Rᵢ≤2.5*d, preferably Rᵢ≤1.5*d, particularly preferably 0.1*d≤Rᵢ≤1.5*d.

6. The battery cell housing according to claim 1,
wherein
the battery cell housing jacket has at least one pressure relief means, preferably at least one bursting element and/or at least one pressure valve, which protects the battery cell housing from exceeding a critical pressure inside the battery cell housing.

7. The battery cell housing according to claim 1,
wherein
a joining seam, in particular a weld seam, is arranged on the long-narrow surface of the battery cell housing jacket.

8. The battery cell housing according to claim 1,
wherein
the surface tension of the aluminium alloy strip, which is fed to the roll forming process, is more than 30 mN/m, preferably more than 40 mN/m, particularly preferably more than 50 mN/m.

9. The battery cell housing according to claim 1,
wherein
the battery cell housing jacket consists of an aluminium alloy of the type AA1xxx having the following composition in wt %:
Si<0.25%,
Fe<0.4%,
Cu<0.2%,
Mn≤0.05%,
Mg<0.5%,
Cr<0.2%,
Zn<0.1%,
0.001%≤Ti≤0.1%,
the remainder being A1 and unavoidable impurities, individually at most 0.05% and in total at most 0.15%.

10. The battery cell housing according to claim 1,
wherein
the battery cell housing jacket consists of an aluminium alloy of the type AA3xxx having the following composition in wt %:
Si<0.6%,
Fe<0.8%,
Cu≤0.5%,
0.3%≤Mn≤1.5%, preferably 0.6%≤Mn≤1.2%,
Mg<1.3%, preferably 0.8%≤Mg≤1.3%, more preferably 0.01%<Mg<0.5%,
Cr<0.2%,
Zn<0.25%,
Ti≤0.1%, preferably 0.001%≤Ti≤0.1%,
the remainder being A1 and unavoidable impurities, individually at most 0.05% and in total at most 0.15%.

11. The battery cell housing according to claim 1,
wherein
the battery cell housing jacket consists of an aluminium alloy of the type AA5xxx having the following composition in wt %:
Si<0.3%,
Fe<0.4%,
Cu<0.2%,
Mn<0.8%,
2.5%<Mg<6.0%, preferably 3.0%<Mg<6.0%,
Cr<0.2%,
Zn<0.25%,
Ti≤0.1%, preferably 0.001%≤Ti≤0.1%,
the remainder being A1 and unavoidable impurities, individually at most 0.05% and in total at most 0.15%.

12. A method for manufacturing a battery cell housing according to claim 1,
wherein
an aluminium alloy strip is manufactured by hot and/or cold rolling from an ingot or a cast strip,
the rolled aluminium alloy strip is further processed by means of roll forming and joining in the longitudinal direction, in particular longitudinal seam welding, to form a closed tubular body made of an aluminium alloy with at least in areas a rectangular cross section, and
the roll-formed tubular body is divided perpendicularly to its longitudinal axis into shorter subsections, which are used as the battery cell housing jacket.

13. The method according to claim 12,
wherein
the aluminium alloy strip is longitudinally seam-welded after the roll forming, the welding speed preferably being more than 2.5 m/min, more than 5 m/min or preferably more than 10 m/min.

14. The method according to claim 12,
wherein
post-processing of the weld seam root is carried out for weld seam root smoothing.

15. The method according to claim 12,
wherein
after cutting the battery cell housing jacket to the required length, one of the two open end faces of the battery cell housing jacket is closed with a form-fit, friction-fit and/or materially by a lid in order to provide a battery cell housing in the form of a cup with at least in areas a rectangular cross section for receiving the electrode winding or electrode stack.

16. The method according to claim 12,
wherein
at least one pressure relief means is introduced or arranged in or on the battery cell housing jacket before, during or after the roll forming process by lasering, embossing, punching, friction-fit and/or materially bonded insertion.
